(19) United States
(12) Patent Application Publication
(10) Pub. No.: US 2015/0286274 A1
(43) Pub. Date: Oct. 8, 2015

(54) POWER SUPPLY DEVICE AND METHOD FOR REDUCING POWER CONSUMPTION OF THE SAME

(71) Applicant: ZIPPY TECHNOLOGY CORP., New Taipei City (TW)

(72) Inventors: Tsun-Te SHIH, New Taipei City (TW); Yu-Yuan CHANG, New Taipei City (TW); Heng-Chia CHANG, New Taipei City (TW)

(73) Assignee: ZIPPY TECHNOLOGY CORP., New Taipei City (TW)

(21) Appl. No.: 14/245,365

(22) Filed: Apr. 4, 2014

(51) Int. Cl. G06F 1/32

(52) U.S. Cl. CPC G06F 1/3296

(57) ABSTRACT

A power supply device with reduced power consumption is electrically connected to a motherboard. The motherboard outputs a power-on signal or a power-off signal to the power supply device when being triggered. The power supply device includes a standby power supply module which modulates an external power to output a standby power. Upon receiving the power-on signal, the power supply device deactivates the standby power supply module, but activates a main power supply module to modulate the external power to output an operating power to the motherboard to replace the standby power. Upon receiving the power-off signal, the power supply device deactivates the main power supply module, but reactivates the standby power supply module so that the standby power supply module outputs the standby power to the motherboard.

### FIELD OF THE INVENTION

The present invention relates to a power supply device and a method for reducing power consumption of the power supply device, and particularly to a power supply device that reduces power consumption through controlling an output of a standby power, and a method for reducing power consumption of the power supply device.

### BACKGROUND OF THE INVENTION

Advanced Technology Extended (ATE) is one of the most common motherboard specifications. A power supply device compliant to the ATX specifications, instead of being directly connected to an activation switch of an information system, is only activated after being triggered by a power-on signal Ps_on from a motherboard. In normal conditions, the power supply device constantly provides a standby power (commonly referred to as 5 Vsb) at all times to allow the motherboard to readily enter an activated state. When the activation switch is pressed by a user, the motherboard immediately outputs the power-on signal Ps_on to the power supply device. The power supply device then utilizes the standby power as an activation power for activating and outputting at least one operating power required for normal operations of the motherboard. The so-called operating power is, for example, 12V, 5V and 3.3V in the ATX power specifications.

Known from the above description, the power supply device in a normal operation mode constantly outputs the standby power which is obtained from an external power modulated by a standby power supply module in a normal operation mode. It should be noted that the standby power supply module is not deactivated nor stopped outputting the standby power when the power supply device is activated. That is to say, once the power supply device is connected to an external power that supplies normally, the standby power supply module consistently modulates the external power to output the standby power. As such, although it is ensured that the motherboard or the power supply device is powered to be operable at all times, power loss is inevitably caused during the process that the standby power supply module modulates the external power. Further, when the power supply device is normally activated, the supply of the operating power mostly satisfies the power consumption needed by the motherboard, meaning that the standby power is not effectively utilized and is rather regarded as waste energy. That is to say, a conventional power supply device does not adjust the modulation and output of the standby power according to a power supply status of the power supply device, which results in a large amount of unnecessary power consumption.

### SUMMARY OF THE INVENTION

Therefore, the primary object of the present invention is to overcome the issue of power waste resulted by a conventional power supply device that constantly provides a standby power.

To achieve the above object, a method for reducing power consumption of a power supply device is provided by the present invention. The method is applied to a power supply device. The power supply device receives an external power, and modulates the external power by a standby power supply module to output a standby power to a motherboard. The power supply device has a power-on status, in which the power supply device receives a power-on signal from the motherboard and modulates the external power by a main power supply module to output an operating power, and a power-off status, in which the power supply device receives a power-off signal from the motherboard and stops the main power supply module from modulating the external power. The method includes the following steps.

In step (I), the motherboard is triggered to output the power-on signal to the power supply device.

In step (II), the power-on signal is received to activate the main power supply module to modulate the external power to output the operating power to the motherboard. Further, after an activation transient period elapses, the standby power supply module is deactivated to stop modulating the external power to replace the supply of the standby power.

In step (III), in the power-on status, the motherboard is triggered to output the power-off signal to the power supply device.

In step (IV), the power-off signal is received to deactivate and stop the main power supply module from modulating the external power, and the standby power supply module is reactivated to modulate the external power to output the standby power to the motherboard.

In one embodiment, before step (I), the method further includes a sub-step of disposing a power management/control unit to connect to the standby power supply module, and rendering the power management/control unit to output a disable signal to the standby power supply module when the power supply device obtains the power-on signal, or to output a re-enable signal to the standby power supply module when the power supply device obtains the power-off signal.

In one embodiment, before step (I), the method further includes a step of connecting the standby power supply module to a standby power output loop to output the standby power to the motherboard.

In one embodiment, step (II) further includes a sub-step of disconnecting the connection between the standby power supply module and the standby power output loop, and connecting the main power supply module to the standby power output loop to output the operating power to the motherboard to replace the supply of the standby power.

In one embodiment, step (IV) further includes a sub-step of disconnecting the connection between the main power supply module and the standby power output loop, and connecting the standby power supply module to the standby power output loop to output the standby power to the motherboard.

A power supply device with reduced power consumption is further provided by the present invention. The power supply device is electrically connected to a motherboard which outputs a power-on signal or a power-off signal to the power supply device when being triggered. The power supply device with reduced power consumption includes a main power supply module, a standby power supply module and a power management/control unit. The main power supply module, electrically connected to the motherboard, modulates an external power upon receiving the power-on signal to output an operating power to the motherboard, or stops modulating the external power upon receiving the power-off signal. The standby power supply module, electrically connected to the motherboard, modulates the external power to output a standby power to the motherboard. The power management/control unit, connected to the standby power supply module, outputs a disable signal to the standby power supply module upon receiving the power-off signal. The disable signal disables the standby power supply module from modulating the external power. The power management/control unit further outputs a re-enable signal to the standby power supply module upon receiving the power-off signal. The re-enable signal reactivates the standby power supply module to modulate the external power. The power supply device has a power-on status, in which the power supply device receives the power-on signal to deactivate the standby power supply module and output the operating power modulated and generated by the main power supply module, and a power-off status, in which the power supply device receives the power-off signal to reactivate the standby power supply module and outputs the standby power modulated and generated by the standby power supply module to the motherboard.

In one embodiment, the power management/control unit includes a power management module and a power control module. The power management module, connected to the motherboard, receives the power-off signal or the power-on signal. The power control module, connected to the standby power supply module, obtains the power-on signal or the power-off signal from the power management module to output the disable signal or the re-enable signal to the standby power supply module.

In one embodiment, the power supply device includes a standby power output loop, and a switch unit disposed on the standby power output loop. The switch unit is controlled by the power management/control unit to determine whether to electrically connect the standby power output loop to the main power supply module or to the standby power supply module.

In one embodiment, the power management module and the power control module are microprocessors.

In one embodiment, the power management/control unit includes an auxiliary power supply loop. The auxiliary power supply loop is electrically connected to the main power supply module to obtain the operating power.

In one embodiment, the power supply device further includes a rectifying/filtering unit that receives the external power, and a power factor connection unit connected to the rectifying/filtering unit.

Through the embodiments, the present invention offers the features below compared to the prior art.

In the present invention, the standby power supply module is activated and deactivated by the power-on signal and the power-off signal, respectively. Thus, the standby power supply module is deactivated when the power supply device is in the power-on status to output the operating power modulated and generated by the main power supply module to the motherboard, thereby preventing the standby power supply module from generating power loss and from reducing overall power consumption of the power supply device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of a power supply device with reduced power consumption according to an embodiment of the present invention;

FIG. 2 is a schematic diagram of waveforms of a power supply device with reduced power consumption according to an embodiment of the present invention;

FIG. 3 is a flowchart of a method for reducing power consumption of a power supply device according to an embodiment of the present invention; and

FIG. 4 is a flowchart of a method for reducing power consumption of a power supply device according to another embodiment of the present invention.

### DETAILED DESCRIPTION OF THE PREFERRED EMBODIMENTS

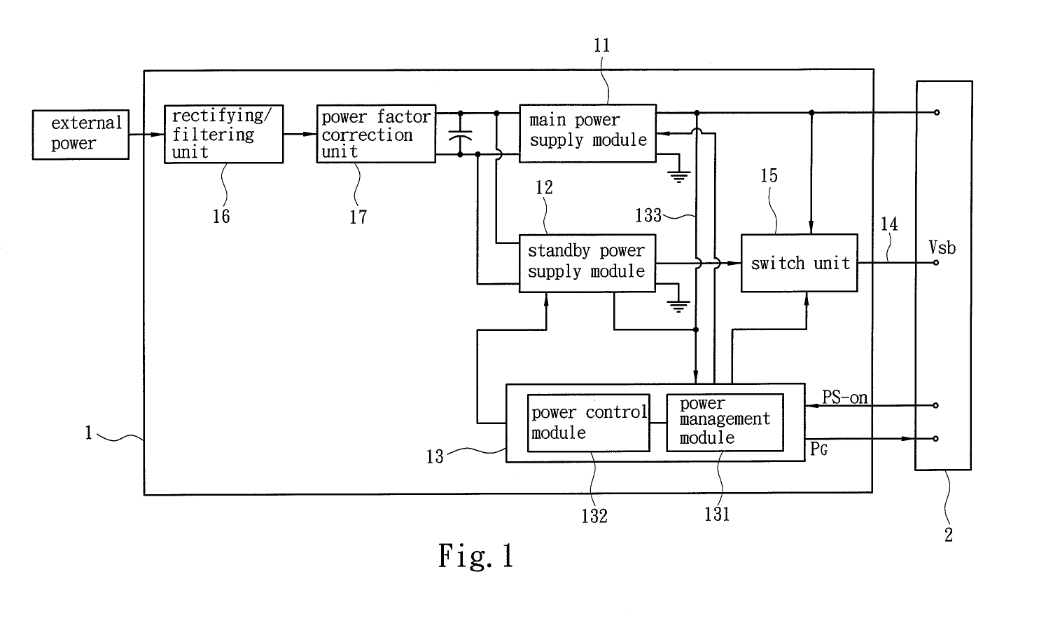

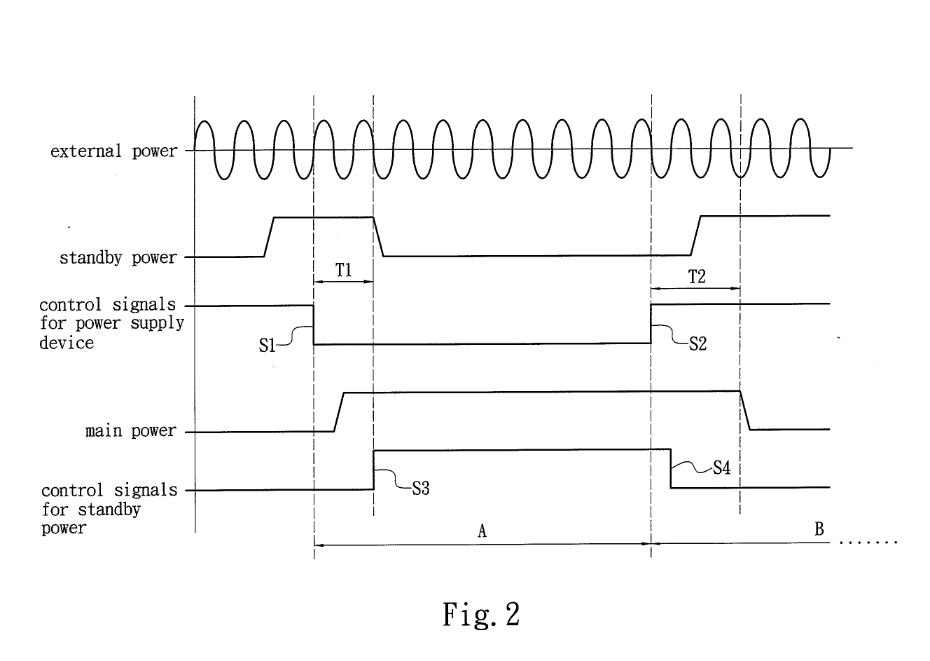

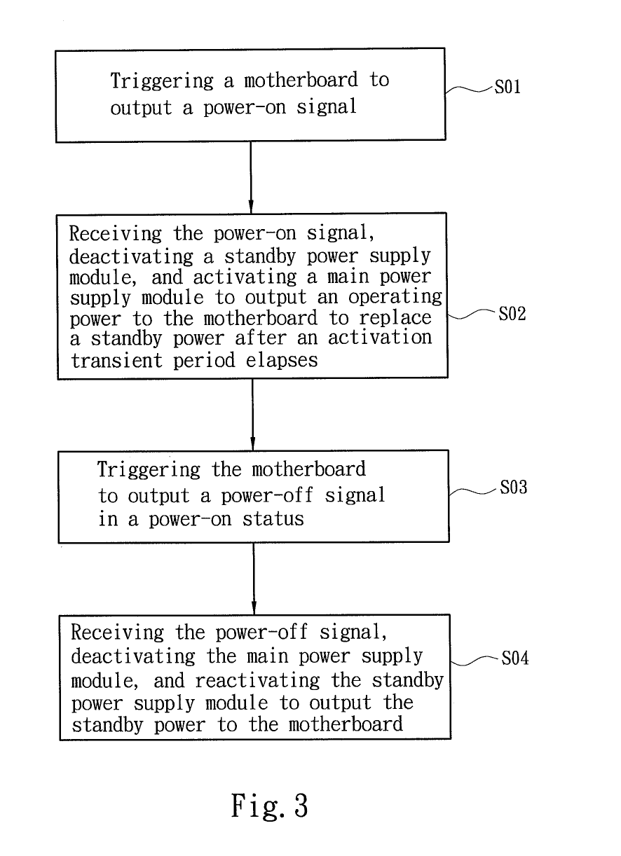

FIG. 1 to FIG. 3 show a power supply device with reduced power consumption and a method for reducing power consumption of the power supply device of the present invention. Referring to FIG. 1 to FIG. 3, a power supply device 1 is electrically connected to a motherboard 2. The motherboard 2 outputs a power-on signal S1 or a power-off signal S2 to the power supply device 1 when being triggered. For example, the power-on signal S1 is a Power Supply On (Ps_on) signal in the ATX standard commonly adopted in the motherboard 2. The power-on signal S1 is outputted to the power supply device 1 before the motherboard 2 is activated. The power-off signal S2 is a trigger signal that prompts the power supply device 1 to stop supplying power when the motherboard 2 is controlled by firmware or software. The power supply device 1 of the present invention includes a main power supply module 11 and a standby power supply module 12. The power supply device 1 receives an external power, and modulates the external power by the standby power supply module 12 to output a standby power to the motherboard 2. The power supply device 1 further has a power-on status and a power off status. When the power supply device 1 receives the power-on signal S1 from the motherboard 2, the power supply device 1 modulates the external power by the main power supply module 11 to output an operating power, thus becoming the power-on status (indicated by a section A in FIG. 2). In the power-on status, the power supply device 1 receives the power-off signal S2 from the motherboard 2, and stops the main power supply module 11 from modulating the external power, thus becoming the power-off status (indicated by a section B in FIG. 2).

Again referring to FIG. 1 to FIG. 3, a method for reducing power consumption of a power supply device of the present invention includes the following steps. In step S01, the motherboard 2 is triggered to output the power-on signal S1 to the power supply device 1. In step S02, the power-on signal S1 is received, such that the main power supply module 11 is activated to modulate the external power to output the operating power to the motherboard 2. Further, after an activation transient period T1 elapses, the standby power supply module 12 is deactivated to stop modulating the external power to replace the supply of the standby power. In step S03, in the power-on status, the motherboard 2 is triggered to output the power-off signal S2 to the power supply device 1. In step S04, the power-off signal S2 is received to deactivate and stop the main power supply module 11 from modulating the external power, and the standby power supply module 12 is reactivated to modulate the external power to output the standby power to the motherboard 2. More specifically, when the power supply device 1 has not yet received the power-on signal S1 from the motherboard 2 when the motherboard 2 is triggered, i.e., before entering step S01, the power supply device 1 modulates the external power by the standby power supply module 12, and outputs the standby power to the motherboard 2 to maintain the motherboard 2 in a standby condition. When the motherboard 2 outputs the power-on signal S1 to the power supply device 1 when being triggered, step S02 is performed. Upon receiving the power-on signal S1, the power supply device 1 activates the main power supply module 11. After the activation transient period T1 elapses, the main power supply module 11 stably outputs the operating power, and the standby power supply module 12 is immediately deactivated to stop modulating the external power. As such, the power supply device 1 suspends the standby power supply module 12 from outputting the standby power to the motherboard 2, but renders the main power supply module 11 to replace the supply of the standby power. Further, when the motherboard 2 outputs the power-off signal S2 to the power supply device 1 when being triggered, step S04 is performed. Upon receiving the power-off signal S2, the power supply device 1 deactivates the main power supply module 11 to stop modulating the external power, and reactivates the standby power supply module 12 to modulate the external power to output the standby power to the motherboard 2, thereby maintaining the power supply device 1 in the standby condition by the standby power. Further, in step S04, in order to ensure normal operations of the power supply device 1, a delay period T2 is implemented after receiving the power-off signal S2, in a way that the main power supply module 11 is deactivated to stop modulating the external power only after the standby power supply module 12 is reactivated and stably outputs the standby power. Thus, in the power-on status of the power supply device 1 of the present invention, the standby power supply module 12 is deactivated, and the operating power modulated and generated by the main power supply module 11 is output to the motherboard 2 to replace the standby power. In the power-off status, the standby power supply module 12 is reactivated, and the standby power modulated and generated by the standby power supply module 12 is outputted to the motherboard 2. In an alternative embodiment, the power supply device 1 further includes a rectifying/filtering unit 16 that receives the external power, and a power factor correction unit 17 connected to the rectifying/filtering unit 16.

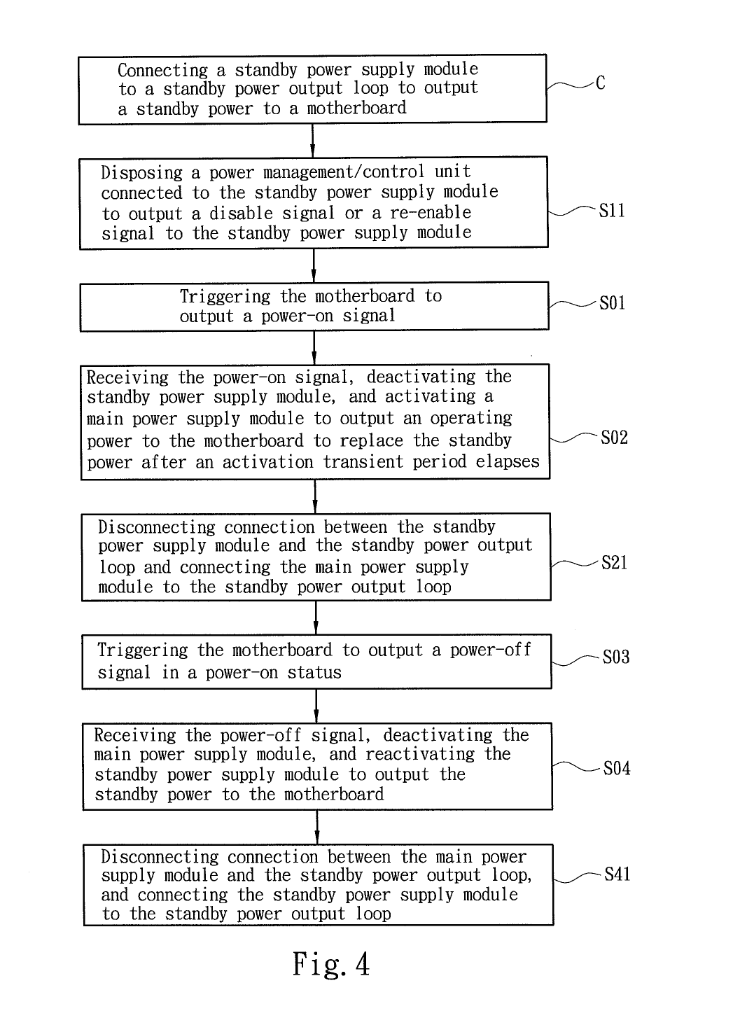

Referring to FIG. 1 and FIG. 4, the power supply device 1 of the present invention may further include a power management/control unit 13 connected to the standby power supply module 12. The power management/control unit 13 receives the power-on signal S1 or the power-off signal S2 from the motherboard 2. Further, upon receiving the power-on signal S1, the power management/control unit 13 outputs a disable signal S3 that deactivates the standby power supply module 12 to stop modulating the external power to the standby power supply module 12. Upon receiving the power-off signal S2, the power management/control unit 13 outputs a re-enable signal S4 that reactivates the standby power supply module 12 to modulate the external power to the standby power supply module 12. When implementing the method of the present invention, step S01 further includes a sub-step S11 of disposing the power management/control unit 13 to connect to the standby power supply module 12, and rendering the power management/control unit 13 to output the disable signal S3 to the standby power supply module 12 when the power supply device 1 obtains the power-on signal S1, or to output the re-enable signal S4 to the standby power supply module 12 when the power supply device 1 obtains the power-off signal S2. The power management/control unit 13 includes a power management module 131 and a power control module 132. The power management module 13, connected to the motherboard 2, receives the power-on signal S1 or the power-off signal S2. The power control module 132, connected to the standby power supply module 12, obtains the power-on signal S1 or the power-off signal S2 from the power management module 131 to correspondingly output the disable signal S3 or the re-enable signal S4 to the standby power supply module 12. The power management module 131 and the power control module 132 may be microprocessors, and control associated units connected, respectively. Further, the power management/control unit 13 includes an auxiliary power supply loop 133. The auxiliary power supply loop 133 is electrically connected to the main power supply module 11 to obtain the operating power.

Again referring to FIG. 1 to FIG. 4, in one embodiment of the present invention, the power supply device 1 further includes a standby power output loop 14, and a switch unit 15 disposed on the standby power output loop 14. The switch unit 15 is controlled by the power management/control unit 13 to determine whether to electrically connect the standby power output loop 14 to the main power supply module 11 or to the standby power supply module 12. Therefore, before step S01, the method of the present invention further includes step C of connecting the standby power supply module 12 to the standby power output loop 14 to output the standby power to the motherboard 2. Step S02 further includes a sub-step S21 of disconnecting the connection between the standby power supply module 12 and the standby power output loop 14, and connecting the main power supply module 11 to the standby power output loop 14 to output the operating power to the motherboard 2 to replace the supply of the standby power. Step S04 further includes sub-step S41 of disconnecting the connection between the main power supply module 11 and the standby power output loop 14, and connecting the standby power supply module 12 to the standby power output loop 14 to output the standby power to the motherboard 2. Further, when implementing the present invention, before the power supply device 1 receives the power-on signal S1, the standby power output loop 14 is connected to the standby power supply module 12, such that the standby power modulated and generated by the standby power supply module 12 is outputted to the motherboard 2. When the power supply device 1 receives the power-on signal S1 from the motherboard 2, the power management/control unit 13 controls the standby power output loop 14 to disconnected the connection with the standby power supply module 12 and to connect to the main power supply module 11, and the operating power modulated and generated by the main power supply module 11 is then outputted via the standby power output loop 14 to the motherboard 2. Further, when the power supply device 1 receives the power-off signal S2 from the motherboard 2, the power management/control unit 13 controls the standby power output loop 14 to disconnect the connection with the main power supply module 11 to again connect to the standby power supply module 12, such that the standby power modulated by the standby power supply module 12 can be outputted to the motherboard 2.

In conclusion, in the power supply device and the method for reducing power consumption of the power supply device, the power supply device is electrically connected to a motherboard. The motherboard outputs a power-on signal or a power-off signal to the power supply device when being triggered. The power supply device includes a standby power supply module which modulates an external power to output a standby power. When the power supply device receives the power-on signal, the power supply device deactivates the standby power supply module, but activates a main power supply module to modulate the external power to output an operating power to the motherboard to replace the standby power. When the power supply device receives the power-off signal, the power supply device deactivates the main power supply module, and reactivates the standby power supply module, such that the standby power module outputs the standby power to the motherboard. As such, in the present invention, through controlling the output time of the standby power supply module, power consumption of the power supply device is reduced.

What is claimed is:

1. A method for reducing power consumption of a power supply device, the power supply device receiving an external power which is modulated by a standby power supply module into a standby power output to a motherboard, the power supply device including a power-on status in which the power supply device receives a power-on signal from the motherboard and modulates the external power by a main power supply module to output an operating power, and a power-off status in which the power supply device receives a power-off signal from the motherboard and stops the main power supply module from modulating the external power, the method comprising the steps of:
triggering the motherboard to output the power-on signal to the power supply device;
activating the main power supply module to modulate the external power into the operating power output to the motherboard when the power supply device receiving the power-on signal, and deactivating the standby power supply module to stop modulating the external power and supplying the standby power after an activation transient period elapses;
triggering the motherboard to output the power-off signal to the power supply device; and
deactivating the main power supply module to stop modulating the external power when the power supply device receiving the power-off signal, and reactivating the standby power supply module to modulate the external power into the standby power output to the motherboard.

2. The method of claim 1 further comprising a sub-step of disposing a power management/control unit to connect to the standby power supply module before the motherboard is triggered to output the power-on signal to the power supply device; the power management/control unit outputting a disable signal to the standby power supply module when the power supply device obtains the power-on signal, or outputting a re-enable signal to the standby power supply module when the power supply device obtains the power-off signal.

3. The method of claim 1 further comprising a sub-step of connecting the standby power supply module to a standby power output loop to output the standby power to the motherboard before the motherboard is triggered to output the power-on signal to the power supply device.

4. The method of claim 3, wherein the step of activating the main power supply module to modulate the external power into the operating power output to the motherboard and deactivating the standby power supply module to stop modulating the external power and supplying the standby power further comprises a sub-step of disconnecting a connection between the standby power supply module and the standby power output loop, and connecting the main power supply module to the standby power output loop to output the operating power to the motherboard.

5. The method of claim 4, wherein the step of deactivating the main power supply module to stop modulating the external power and reactivating the standby power supply module to modulate the external power into the standby power output to the motherboard further comprises a sub-step of disconnecting a connection between the main power supply module and the standby power output loop, and connecting the standby power supply module to the standby power output loop to output the standby power to the motherboard.

6. A power supply device with reduced power consumption, electrically connected to a motherboard, the motherboard outputting a power-on signal or a power-off signal to the power supply device when being triggered, the power supply device comprising:
a main power supply module, electrically connected to the motherboard, modulating an external power into an operating power output to the motherboard upon receiving the power-on signal, or stopping modulating the external power upon receiving the power-off signal;
a standby power supply module, electrically connected to the motherboard, modulating the external power into a standby power output to the motherboard; and
a power management/control unit, connected to the standby power supply module, outputting a disable signal to the standby power supply module upon receiving the power-on signal to disable the standby power supply module from modulating the external power, or outputting a re-enable signal to the standby power supply module upon receiving the power-off signal to reactivate the standby power supply module to modulate the external power;
wherein, the power supply device includes a power-on status, in which the power supply device receives the power-on signal to deactivate the standby power supply module and output the operating power modulated and generated by the main power supply module to the motherboard, and a power-off status, in which the power supply device receives the power-off signal to reactivate the standby power supply module and output the standby power modulated and generated by the standby power supply module to the motherboard.

7. The power supply device according to claim 6 further comprising a standby power output loop and a switch unit disposed on the standby power output loop, wherein the switch unit is controlled by the power management/control unit to determine whether to electrically connect the standby power output loop to the main power supply module or to the standby power supply module.

8. The power supply device according to claim 6, wherein the power management/control unit comprises a power management module and a power control module; the power management module being connected to the motherboard to receive the power-on signal or the power-off signal; the power control module, connected to the standby power supply module, obtaining the power-on signal or the power-off signal from the power management module to output the disable signal or the re-enable signal to the standby power supply module.

9. The power supply device according to claim 8, wherein the power management module and the power control module are microprocessors.

10. The power supply device according to claim 8 further comprising a standby power output loop and a switch unit disposed on the standby power output loop, wherein the switch unit is controlled by the power management/control unit to determine whether to electrically connect the standby power output loop to the main power supply module or to the standby power supply module.

11. The power supply device according to claim 10, wherein the power management module and the power control module are microprocessors.

12. The power supply device according to claim 6, wherein the power management/control unit comprises an auxiliary power supply loop electrically connected to the main power supply module to obtain the operating power.

13. The power supply device according to claim 6 further comprising a rectifying/filtering unit receiving the external power, and a power factor correction unit connected to the rectifying/filtering unit.
